(19) United States
(12) Patent Application Publication
(10) Pub. No.: US 2012/0098978 A1
(43) Pub. Date: Apr. 26, 2012

(54) PORTABLE COMMUNICATION TERMINAL, UPLOAD CONTROL PROGRAM, AND UPLOAD CONTROL METHOD

(75) Inventor: Naotaka YASUDA, Osaka (JP)

(73) Assignee: KYOCERA CORPORATION, Kyoto (JP)

(21) Appl. No.: 13/276,874

(22) Filed: Oct. 19, 2011

(30) Foreign Application Priority Data
Oct. 21, 2010 (JP) 2010-236276

(51) Int. Cl. H04N 5/225

(52) U.S. Cl. 348/207.1; 348/E05.024

(57) ABSTRACT

A portable communication terminal, an upload control program, and an upload control method are provided. The portable communication terminal includes an image taking unit configured to output taken image data, an analyzing unit configured to analyze an attribute which the image data represents, a determining unit configured to determine whether an analysis result of the analyzing unit satisfies a predetermined condition, and an uploading unit configured to upload the image data to an upload server when the determining unit determines that the analysis result satisfies the predetermined condition.

### CROSS-REFERENCE TO RELATED APPLICATION

This application claims priority from Japanese Patent Application No. 2010-236276, filed on Oct. 21, 2010, the entire subject matter of which is incorporated herein by reference.

### BACKGROUND OF THE INVENTION

1. Field of the Invention

The present invention relates to a portable communication terminal, an upload control program, and an upload control method, and more particularly, to a portable communication terminal, an upload control program, and an upload control method which are capable of uploading images.

2. Description of the Related Art

Portable communication terminals capable of uploading images have been widely known. An example of this kind of devices is described in JP-A-2005-303374. According to this document, an internet camera is connected to a temperature and humidity sensor. For example, in a case where the temperature is 40 degrees C. or higher or the humidity is 80% or higher, taken images are converted into image data and transmitted to a file server.

However, in the internet camera described in JP-A-2005-303374, only information when images are taken can be set as a condition, and a user cannot set specific conditions.

### SUMMARY OF THE INVENTION

Accordingly, as aspect of the present invention provides a new portable communication terminal, a new upload control program, and a new upload control method.

Another aspect of the present invention provides a portable communication terminal, an upload control program, and an upload control method which are capable of setting specific conditions.

According to an illustrative embodiment of the present invention, there is provided a portable communication terminal including an image taking unit configured to output taken image data, an analyzing unit configured to analyze an attribute which the image data represents, a determining unit configured to determine whether an analysis result of the analyzing unit satisfies a predetermined condition, and an uploading unit configured to upload the image data to an upload server when the determining unit determines that the analysis result satisfies the predetermined condition.

According to the above configuration, since it is enabled to set an attribute which image data represents, as a condition for upload, the user can set a detailed condition.

The above portable communication terminal may further include an editing unit configured to perform an editing process on the image data when the determining unit determines that the analysis result satisfies the predetermined condition, and the uploading unit may upload the image data edited by the editing unit.

According to this configuration, the user does not need to edit images in advance, and thus the convenience of the user is improved.

The above portable communication terminal may further include an input unit configured to receive an input operation, and a registering unit configured to register a result of the input operation to the input unit as the predetermined condition.

According to this configuration, since the predetermined conditions can be registered by an input operation, the user can register a filter reflecting the intention of the user.

The above portable communication terminal may further include a setting unit configured to set the image data as image data incapable of transmission when the determining unit determines that the analysis result does not satisfy the predetermined condition.

According to this configuration, it is possible to easily classify uploaded image data and image data incapable of uploading.

In the above portable communication terminal, the predetermined condition may be registered in association with address information of the upload server.

According to this configuration, it is possible to change only address information associated to registered predetermined conditions. Therefore, it is possible to effectively use the registered predetermined conditions.

In the above portable communication terminal, the analyzing unit may analyze a luminance value of the image data, and the predetermined condition may include whether the luminance value of the image data is a predetermined value or more.

In the above portable communication terminal, the analyzing unit may analyze a smile degree of the image data, and the predetermined condition may include whether the smile degree of the image data is a predetermined value or more.

According to this configuration, it is possible to set a smiling face of a photographic object as an attribute which the image data represents.

In the above portable communication terminal, the editing unit may perform, as the editing processes, at least one of a red-eye correction process, a skin-tone correction process, a noise reduction process, and a color correction process, on the image data.

According to this configuration, it is possible to perform at least one of the red-eye correction process, the skin-tone correction process, the color correction process, and the noise reduction process on image data taken for upload.

According to another illustrative embodiment of the present invention, there is provided a non-transitory computer-readable medium having an upload control program stored thereon and readable by a processor included in a portable communication terminal having an image taking unit configured to output taken image data, the upload control program, when executed by the processor, causing the processor to perform operations including analyzing an attribute which the image data represents, determining whether an analysis result satisfies a predetermined condition, and uploading the image data to an upload server when it is determined that the analysis result satisfies the predetermined condition.

According to the above configuration, since it is enabled to set an attribute which image data represents, as a condition for upload, the user can set a detailed condition.

According to a further illustrative embodiment, there is provided an upload control method of a portable communication terminal having an image taking unit configured to output taken image data, the method including analyzing an attribute which the image data represents, determining whether an analysis result satisfies a predetermined condition, and uploading the image data to an upload server when it is determined that the analysis result satisfies the predetermined condition.

According to the above configuration, since it is enabled to set an attribute which image data represents, as a condition for upload, the user can set a detailed condition.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a block diagram illustrating an electrical configuration of a portable communication terminal according to an illustrative embodiment of the present invention;

FIGS. 2A to 2F are conceptual views illustrating examples of image data stored in a flash memory shown in FIG. 1;

FIGS. 3A and 3B are schematic views illustrating examples of an input screen displayed on a display shown in FIG. 1;

FIGS. 4A and 4B are conceptual views illustrating examples of a filter table stored in a RAM shown in FIG. 1;

FIG. 5 is a schematic view illustrating an example of a menu screen displayed on the display shown in FIG. 1;

FIGS. 6A to 6C are conceptual views illustrating flows for uploading image data to an upload server shown in FIG. 1;

FIG. 7 is a conceptual view illustrating an example of an image management table stored in the RAM shown in FIG. 1;

FIG. 8 is a conceptual view illustrating an example of a memory map of the RAM shown in FIG. 1;

FIG. 9 is a flow chart illustrating a filter registering process of a processor shown in FIG. 1;

FIG. 10 is a flow chart illustrating a filter setting process of the processor shown in FIG. 1;

FIG. 11 is a flow chart illustrating an image taking process of the process shown in FIG. 1; and

FIG. 12 is a flow chart illustrating an upload process of the processor shown in FIG. 1.

### DETAILED DESCRIPTION OF THE INVENTION

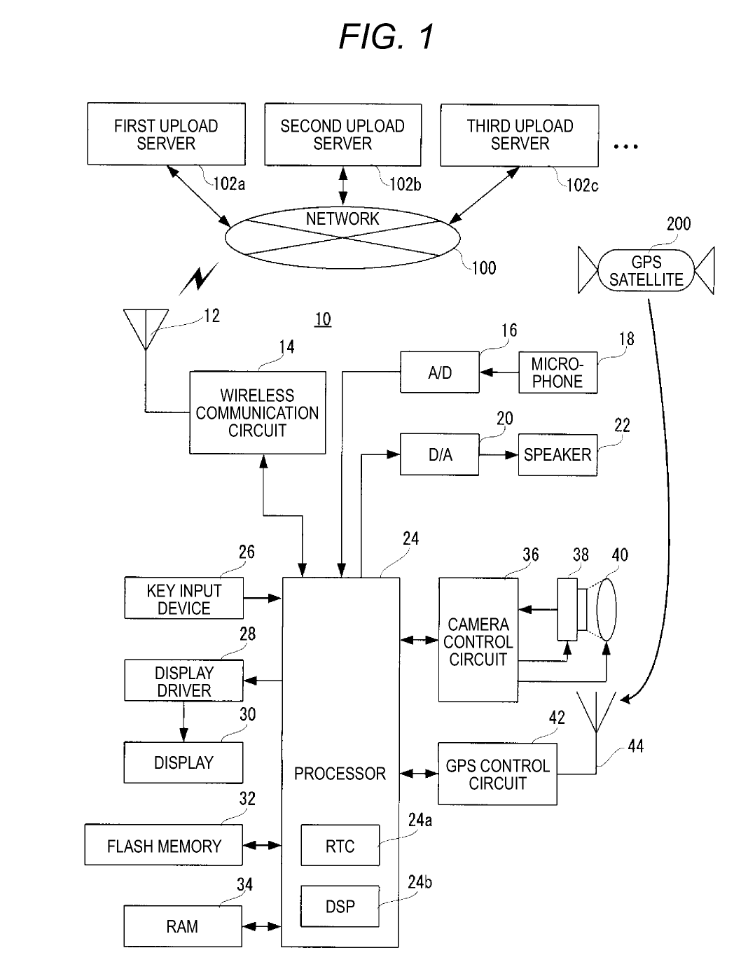

Referring to FIG. 1, a portable phone 10 according to an illustrative embodiment is an example of a portable communication terminal, and includes a processor 24 called a CPU. The processor 24 is connected to a wireless communication circuit 14, an A/D converter 16, a D/A converter 20, a key input device 26, a display driver 28, a flash memory 32, a RAM 34, a camera control circuit 36, and a GPS control circuit 42. The wireless communication circuit 14 is connected to an antenna 12, and the A/D converter 16 is connected to a microphone 18. The D/A converter 20 is connected to a speaker 22 through an amplifier (not shown). The display driver 28 is connected to a display 30. The camera control circuit 36 is connected to an image sensor 38, and is connected to a lens monitor (not shown) for controlling a focal length of a focal lens 40. Further, the GPS control circuit 42 is connected to a GPS antenna 44.

The processor 24 controls the entire portable phone 10. Further, the processor 24 includes an RTC 24a for outputting current time information, and a digital signal processor (DSP) 20 for processing digital signals. The RAM 34 is used as a work area (including a drawing area) for the processor 24 or a buffer area. The flash memory 32 stores contents data of the portable phone 10, such as characters, images, voices, sounds, and videos.

The A/D converter 16 converts analog audio signals on voices and sounds, input through the microphone 18 connected to the A/D converter 16, into digital audio signals. The D/A converter 20 converts (decodes) the digital audio signals into the analog audio signals, and outputs the analog audio signals to the speaker 22 through the amplifier. Therefore, the voices and sounds corresponding to the analog audio signals are output from the speaker 22.

The key input device 26 is an input unit, and includes a call-starting key, a call-ending key, and so on. If a user operates keys, information on the keys (key data) is input to the processor 24. If each key of the key input device 26 is operated, a clicking tone is generated. Therefore, the user can have an operational feeling on the key operation by listening to the clicking tone. When a function is being executed, if the call-ending key is operated, the portable phone 10 ends the function currently being executed and transitions to a standby mode.

The display driver 28 controls display of the display 30 connected to the display driver 28, under the instruction of the processor 24. Further, the display driver 28 includes a video memory (not shown) for temporarily storing image data to be displayed.

The wireless communication circuit 14 is a circuit for CDMA radio communication. For example, if the user makes a telephone call (outgoing call) using the key input device 26, the wireless communication circuit 14 executes an outgoing call process under the instruction of the processor 24, and outputs an outgoing call signal to the antenna 12. The outgoing call signal is transmitted to a telephone of the other party through base stations and communication networks (not shown). If a receiving process is performed in the telephone of the called party, a communication-enabled state is established, and the processor 24 performs a calling process.

Specifically, in a normal calling process, a modulated audio signal transmitted from the telephone of the other party is received by the antenna 12. The received modulated audio signal is demodulated and decoded by the wireless communication circuit 14. Then, the processed received audio signal is converted into an analog audio signal by the D/A converter 20 and then is output from the speaker 22. Meanwhile, a transmission audio signal acquired through the microphone 18 is converted into a digital audio signal by the A/D converter 16 and is transmitted to the processor 24. The digital transmission audio signal is encoded and modulated by the wireless communication circuit 14, under the instruction of the processor 24, and is output through the antenna 12. Therefore, the modulated audio signal is transmitted to the telephone of the other party through base stations and communication networks.

Meanwhile, if an incoming call signal is received from the telephone of the other party by the antenna 12, the wireless communication circuit 14 notifies the reception of a telephone call (incoming call) to the processor 24. Then, the processor 24 controls the display driver 28 such that the display 30 displays caller information (telephone number) described in the call reception notification. About the same time as this, the processor 24 outputs a ring tone (which may be a ringing melody or a ringing voice) from the speaker (not shown).

Then, if the user performs response operation on the call-starting key, the wireless communication circuit 14 performs a call receiving process under the instruction of the processor 24. Then, a communication-enabled state is established, and the processor 24 performs the above-mentioned normal calling process.

In the communication-enabled state, if call ending operation is performed on the call-ending key, the processor 24 controls the wireless communication circuit 14, such that a call ending signal is transmitted to the other party. After the call ending signal is transmitted, the processor 24 ends the calling process. Even in a case where a call ending signal is first received from the other party, the processor 24 ends the calling process. Further, even when a call ending signal is received from a mobile communication network, not from the other party, the processor 24 ends the calling process.

The camera control circuit 36 is a circuit for taking still images or moving images with the portable phone 10. For example, if an operation for executing a camera function is performed on the key input device 26, the processor 24 activates the camera control circuit 36 such that the camera function is executed. The camera control circuit 36, the image sensor 38, and the focal lens 40 are referred to collectively as a camera module or an image taking unit.

For example, an optical image of a photographic object is irradiated onto the image sensor 38, and is photoelectrically converted in an imaging area of the image sensor 38, such that an electric charge, that is, a raw image signal corresponding to the optical image of the photographic object is generated. The imaging area includes photo-sensitive elements, which may be arranged corresponding to SXGA (1280×1024 pixels). In this case, a raw image signal corresponding to SXGA is generated. The user can change the size of image data to XGA (1024×768 pixels), VGA (640×480 pixels), or the like, other than SXGA.

If the camera function is executed, in order to display real-time moving images, that is, through-the-lens images of the photographic object on the display 30, the processor 24 activates an image sensor driver built in the camera control circuit 36 and instructs the image sensor driver to perform an exposure operation and an electric-charge reading operation for a specified readout area.

The image sensor driver allows exposure of an imaging surface of the image sensor 38, and reading of an electric charge generated by the exposure. As a result, a raw image signal is output from the image sensor 38. The output raw image signal is input to the camera control circuit 36, and the camera control circuit 36 performs processes, such as color separation, white balance adjustment, and YUV conversion, on the input raw image signal, so as to generate YUV image data. The YUV image data is input to the processor 24. In this case, the camera control circuit 36 controls the focal lens 40 such that a focus is put on the photographic object.

Further, the YUV image data input to the processor 24 is (temporarily) stored in the RAM 34 by the processor 24. The stored YUV image data is converted into RGB image data by the processor 24 and then is transmitted form the RAM 34 to the display driver 28. Next, the RGB image data is output to the display 30. In this way, the through-the-lens images showing the photographic object are displayed at a low resolution (for example, 320×240 pixels) on the display 30.

In this state, if an operation for taking a still image is performed on the key input device 26, the processor 24 performs a main image taking process for a still image. In other words, the processor 24 performs a signal process on the raw image signal output from the image sensor 38, temporarily stores the processed image signal in the RAM 34, and performs a recording process on the flash memory 32. If the recording process is performed, the image data is read from the RAM 34 by the processor 24. Then, the processor 24 records the read image data in association with meta information as one file in the flash memory 32. Further, the processor 24 outputs a sound for notifying that the main image taking process is being performed, from the speaker (not shown).

In a case where a memory card is connected to the portable phone 10, the image data may be stored in the memory card. The meta information associated with the image data is stored in Exif format.

If the user sets a video mode and performs an operation for taking a video, the processor 24 performs a main image taking process for a video. In this case, the processor 24 issues an instruction for outputting a VGA raw image signal at a predetermined frame rate, to the camera control circuit 36. Then, similarly to the main image taking process for a still image, the processor 24 performs a plurality of processes on each raw image signal read at the predetermined frame rate, and stores the video data in the flash memory 32.

The GPS control circuit 42 is activated in a case of performing a process for measuring (acquiring) a current position. The GPS antenna 44 receives a GPS signal transmitted from a GPS satellite 200, and outputs the GPS signal to the GPS control circuit 42. Then, the processor 24 performs three-dimensional measurement on the basis of the received GPS signal, and computes the latitude, longitude, and altitude (elevation) of the current position. Although only one GPS satellite 200 is shown in FIG. 1 for simplicity, in order to measure the current position, it is required to receive GPS signals from at least four GPS satellite 200. However, in a case where GPS signals can be received from only three GPS satellite 200, instead of the three-dimensional measurement, two-dimensional measurement is performed. In this case, the altitude is not computed.

Also, the portable phone 10 has a data communication function. If the data communication function is executed, the portable phone 10 performs data communication with a first upload server 102a, a second upload server 102b, and a third upload server 102c (generally referred to as upload servers 102 when it is unnecessary to distinguish them) through a network 100. Therefore, the portable phone 10 can upload (transmit) data to the upload servers 102.

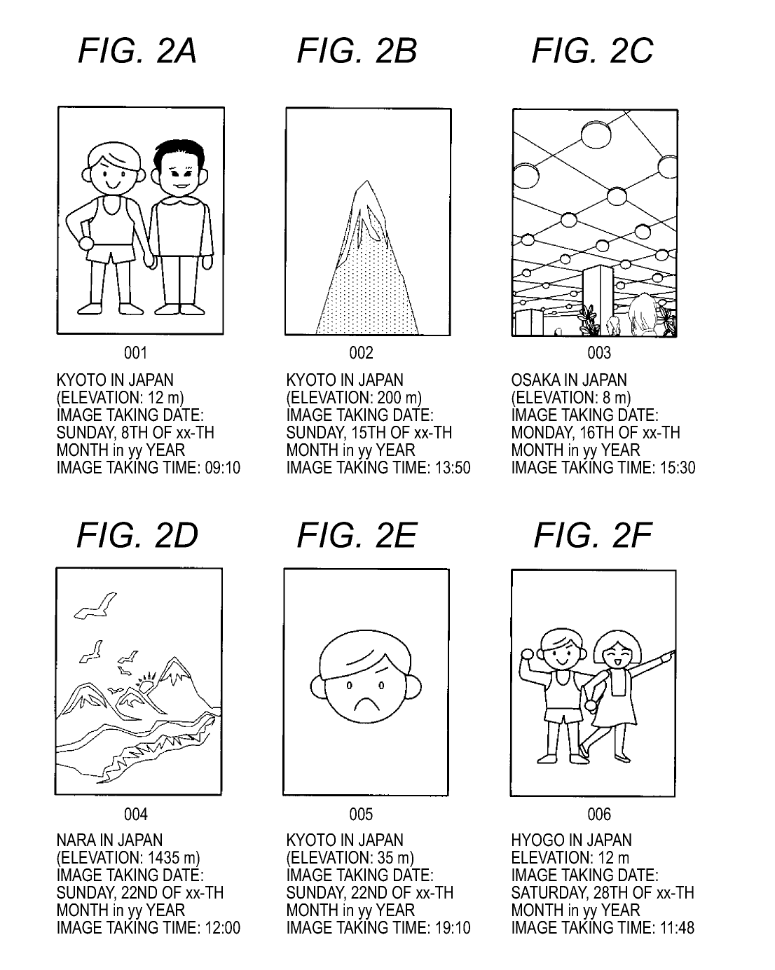

FIGS. 2A to 2F are views illustrating examples of image data stored in the flash memory 32. For example, the stored image data are given numerical names in the image taking order. The image data is associated with the meta image taking position information including the image taking position, the elevation, the image taking date, and the image taking time. The image taking position and the elevation is determined on the basis of the latitude, the longitude, and the altitude according to the GPS signal from the GPS satellites 200. The image taking date and the image taking time are obtained from time information which the RTC 24a outputs.

For example, if image taking operation is performed at Kyoto at 9:10 on Sunday, the 8th of xx-th month in yy year, image data as shown in FIG. 2A is stored in the flash memory 32. Specifically, the taken image data is given a name ‘001’. The image data ‘001’ is associated with metal information which includes ‘Kyoto in Japan’ as the image taking position, ‘12 m’ as the elevation, ‘Sunday, the 8th of xx-th month in yy year’ as the image taking date, and ‘9:10’ as the image taking time. The image taking position may be represented by numerical values indicating the latitude and longitude.

Referring to FIG. 2B, image data ‘002’ is associated with meta information which includes ‘Kyoto in Japan’ as the image taking position, ‘200 m’ as the elevation, ‘Sunday, the 15th of xx-th month in yy year’ as the image taking date, and ‘13:50’ as the image taking time. Referring to FIG. 2C, image data ‘003’ is associated with meta information which includes ‘Osaka in Japan’ as the image taking position, ‘8 m’ as the elevation, ‘Monday, the 16th of a xx-th month in yy year’ as the image taking date, and ‘15:30’ as the image taking time.

Referring to FIG. 2D, image data ‘004’ is associated with meta information which includes ‘Nara in Japan’ as the image taking position, ‘1435 m’ as the elevation, and ‘Sunday, the 22nd of xx-th month in yy year’ as the image taking date. Referring to FIG. 2E, image data ‘005’ is associated with meta information which includes ‘Kyoto in Japan’ as the image taking position, ‘35 m’ as the elevation, ‘Sunday, the 22nd of xx-th month in yy year’ as the image taking date, and ‘19:00’ as the image taking time. Referring to FIG. 2F, image data ‘006’ is associated with meta information which includes ‘Hyogo in Japan’ as the image taking position, ‘12 m’ as the elevation, ‘Saturday, the 28th of xx-th month in yy year’ as the image taking date, and ‘11:48’ as the image taking time.

In the present illustrative embodiment, in a case where image data stored in the flash memory 32 satisfies predetermined conditions, the corresponding image data is uploaded to a certain upload server 102. Further, in the case where the image data satisfies the predetermined conditions, prior to the upload, editing processes (image processes), such as red-eye correction, skin tone correction, a color correction process, and a noise reduction process, are performed on the image data.

First, a filter for determining whether the predetermined conditions are satisfied is registered in the portable phone 10. The predetermined conditions include image taking conditions based on the meta information, and image conditions based on attributes which the image data represents, and the filter includes items corresponding to those conditions. The attributes which the image data represents mean the attributes of the image data, and can be obtained by performing an analysis process on the image data. For example, in the present illustrative embodiment, a human detection process, a smiling-face detection process, a luminance detection process, and an image difference detection process (referred to collectively as the analysis process) are performed on the image data, so as to obtain a human detection result, a smiling-face detection result, an average luminance value, and a difference detection result which are utilized as the attributes of the image data.

The average luminance value is a value obtained by averaging luminance values of individual pixels of the image data. The average luminance value may be obtained from the luminance values of all pixels of the image data or may be obtained from luminance values of some pixels. The average luminance value may be also referred to simply as the luminance value.

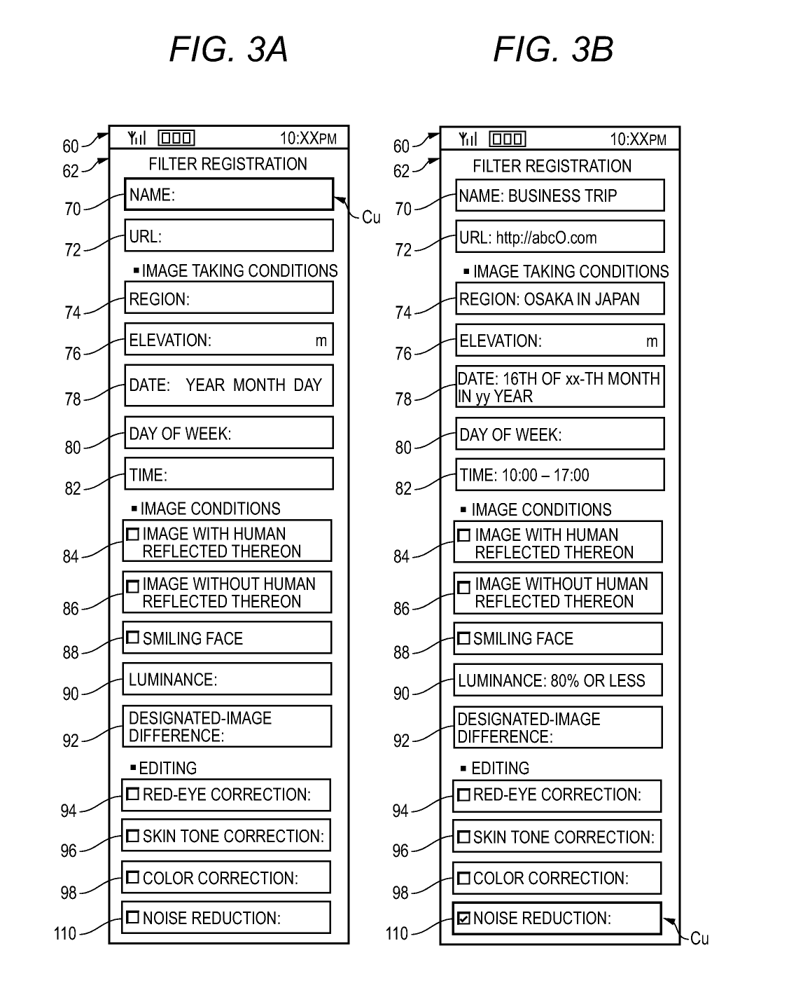

Referring FIG. 3A, if the user performs operation for registering a filter, an input screen is displayed on the display 30. A display area of the display 30 displaying the input screen includes a state display area 60 and a function display area 62. In the state display area 60, icons (also referred to as pictographs) representing a radio wave state of the antenna 12 and the remaining capacity of a secondary battery, and current date and time are displayed. The current time is based on the time information output from the RTC 24a. In FIGS. 3A and 3B, each of the entire input screens is shown as one figure; however, since a display range of the display 30 is smaller than the input screens, actually, only a portion of each input screen is displayed on the display 30.

In the function display area 62, a plurality of icons corresponding to the individual items constituting the predetermined conditions, and a cursor Cu for icon selection are displayed. A name icon 70 is an icon for inputting a name of a file, and an URL icon 72 is an icon for inputting an URL (address information) of an upload destination of the image data.

A region icon 74 is an icon for setting a region (place) as a predetermined condition. An elevation icon 76 is an icon for setting an elevation (altitude) as a predetermined condition. A date icon 78 is an icon for setting date and time as a predetermined condition. A day-of-the-week icon 80 is an icon for setting a day of the week as a predetermined condition. A time icon 82 is an icon for setting a period of time as a predetermined condition.

A first reflection icon 84 is an icon for setting images with humans reflected thereon as a predetermined condition. A second reflection icon 86 is an icon for setting images without humans reflected thereon as a predetermined condition. A smiling face icon 88 is an icon for setting images of smiling humans as a predetermined condition. A luminance icon 90 is an icon for setting an average luminance value of image data as a predetermined condition. A designated-image difference icon 92 is an icon for setting images different from image data designated by the user, as a predetermined condition.

A red-eye correction icon 94 is an icon for setting whether to perform a red-eye correction process on image data satisfying the predetermined conditions. A skin-tone correction icon 96 is an icon for setting whether to perform a skin tone correction process on the image data satisfying the predetermined conditions. A color correction icon 98 is an icon for setting whether to perform a color correction process on the image data satisfying the predetermined conditions. A noise reduction icon 110 is an icon for setting whether to perform a noise reduction process on the image data satisfying the predetermined conditions.

The position of the cursor Cu can be operated by an operation key included in the key input device 26, and if operation for confirming a selection by the cursor Cu is performed, it is possible to set an item corresponding to an icon by input keys included in the key input device 26. In a case where a selection of an icon with a check box attached thereto is confirmed, a corresponding item is switched on or off.

The user does not need to input all of the items, and may input only necessary items.

For example, a case of registering a filter named ‘BUSINESS TRIP’ will be described with reference to FIG. 3B. First, ‘BUSINESS TRIP’ is input in the name icon 70, and ‘http://abcO.com’ (first upload server 102a) is input in the URL icon 72. In the image taking conditions, ‘Osaka in Japan’ is input in the region icon 74, ‘26th of xx-th month in yy year’ is input in the date icon 78, and ‘10:00 to 17:00’ is input in time icon 82. In the image conditions, ‘80% or less’ is input in the luminance icon 90. In the editing, a check mark is input in the noise reduction icon 110. Then, if the user performs registration operation on the key input device 26, the filter ‘BUSINESS TRIP’ is registered.

In the filter ‘BUSINESS TRIP’, inputting has not been performed on the elevation icon 76, the day-of-the-week icon 80, and the designated-image difference icon 92, and a check mark has not been input in check boxes of the first reflection icon 84, the second reflection icon 86, and the smiling face icon 88. In editing of the filter, a check mark is not input in the red-eye correction icon 94, the skin-tone correction icon 96, and the color correction icon 98.

Therefore, when the filter ‘BUSINESS TRIP’ is valid, if image data has been taken at Osaka in Japan in a period of time from 10:00 to 17:00 of the 26th of xx-th month in yy year and has an average luminance value of 80% or less, the corresponding image data is transmitted to the first upload server 102a designated by ‘http://abcO.com’. Further, since the noise reduction icon 110 has been checked in the editing, prior to uploading to the first upload server 102a, a noise reduction process is performed on the image data.

Accordingly, prior to uploading, an editing process can be performed on image data. Therefore, the user does not need to edit images in advance, and thus the convenience of the user is improved. Further, since the predetermined conditions (filter) can be registered by key operation (input operation) on the key input device 26, the user can register a filter reflecting the intention of the user. Furthermore, in the present illustrative embodiment, a process for analyzing an average luminance value of the image data having been widely used can be used. Moreover, it is possible to set whether a photographic object is smiling, as an attributes that image data represents.

In FIG. 3B, only one day has been set in the date icon 78. However, like the time icon 82, a period, for example, ‘from the 26th in xx-th month in yy year to the 31st in xx-th month in yy year’, may be set. Similarly, also in the luminance icon 90, a range, for example, ‘from 30% to 80%’ may be set.

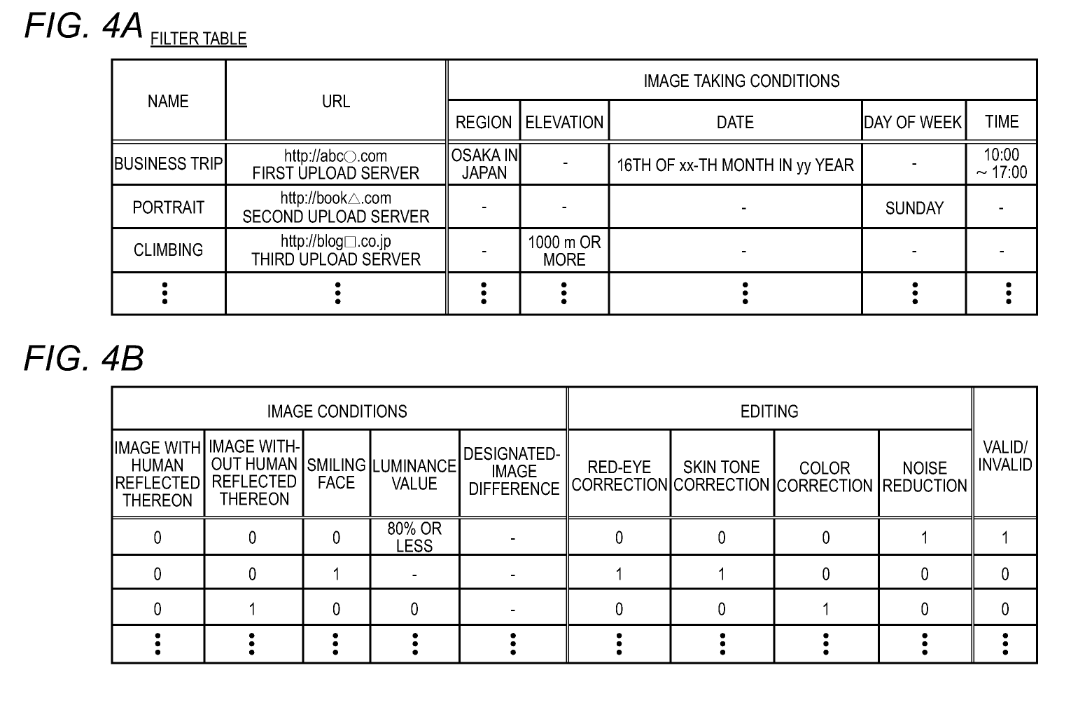

FIGS. 4A and 4B are views illustrating the contents of a filter table generated by registered filters. A filter table includes a name column, an URL column, an image taking condition column, an image condition column, an editing column, and a valid/invalid column, and registered filters correspond to each row. Further, the image taking condition column includes a region column, an elevation column, a date column, a day-of-the-week column, and a time column, and the image condition column includes a first reflection column, a second reflection column, a smiling face column, an average luminance value column, a designated-image difference column. Furthermore, the editing column includes a red-eye correction column, a skin-tone correction column, and a noise reduction column.

In the filter table shown in FIGS. 4A and 4B, in addition to a business trip filter, a portrait filter and a climbing filter have been registered. For example, in a case where the portrait filter is valid, if image data is taken on Sunday and includes a smiling human as a photographic object, a red-eye correction process and a skin tone correction process are performed on the image data and then is uploaded to the second upload server 102b. In a case where the climbing filter is valid, if image data is taken at a place having an elevation of 1000 m or more and does not include a human, a color correction is performed on the image data, and then is uploaded to the third upload server 102c.

In an item on which any input has not been performed, a mark ‘—’ representing that any setting has not been performed is registered. Further, in FIGS. 3A and 3B, in a cell corresponding to an icon with a check box attached thereto, a value ‘1’ representing an ON state or a value ‘0’ representing an OFF state is registered.

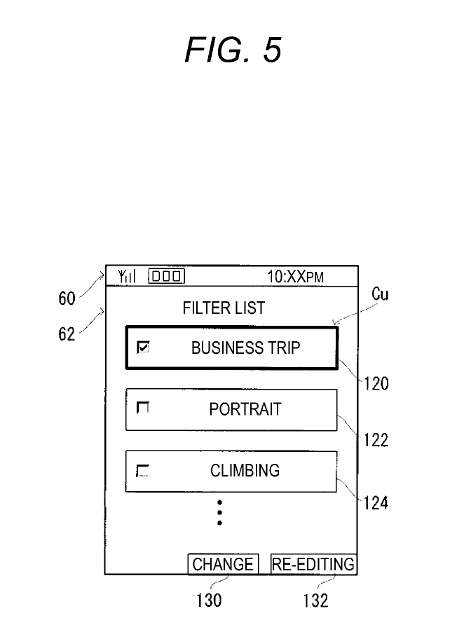

Similarly, in the rightmost column of FIG. 4B representing the valid/invalid of the filters, a value ‘1’ representing valid or a value ‘0’ representing invalid is registered. The valid/invalid of the filters is switched by using a GUI shown in FIG. 5.

If the user performs a filter setting operation, a list screen shown in FIG. 5 is displayed on the display 30. Referring to FIG. 5, the list screen includes a business trip icon 120, a portrait icon 122, and a climbing icon 124 corresponding to the registered filters, and the cursor Cu for icon selection, a switch key 130, and an editing key 132. The icons corresponding to the filters include check boxes, and if a check mark is in a check box of an icon, a filter corresponding to the icon is valid, and if a check mark is not in a check box of an icon, a filter corresponding to the icon is invalid. The user can select an icon corresponding to a filter by the cursor Cu and operate the switch key 130 to switch existence/non-existence of a check mark, that is, the valid/invalid of the filter.

For example, in FIG. 5, since a check mark is in the check box of the business trip icon 120, the business trip filter is valid. Further, since a check mark is not in the check boxes of the portrait icon 122 and the climbing icon 124, the portrait filter and the climbing filter is invalid. If the business trip icon 120 is selected by the cursor Cu and then the switch key 130 is operated, in the check box of the business trip icon 120, the check mark is cancelled, and the business trip filter becomes invalid. In this case, in the filter table shown in FIG. 4B, a cell corresponding to the valid/invalid of the business trip filter is switched from ‘1’ to ‘0’.

If an icon is selected by the cursor Cu and the editing key 132 is operated, a filter corresponding to the icon can be edited. For example, if the business trip icon 120 is selected by the cursor Cu and then the editing key 132 is operated, the input screen shown in FIG. 3B is displayed on the display 30. Then, the user can arbitrarily edit the registered filter.

The user can change only an URL associated with a registered filter by editing. In other words, it is possible to effectively use the registered filters. In other illustrative embodiments, it may be made possible to copy the contents of a registered filter. In this case, when a new filter is registered, the copied contents can be used.

The switch key 130 and the editing key 132 are soft keys, and corresponding keys exists in the key input device 26. Therefore, the user can operate the switch key 130 and the editing key 132 by operating the corresponding keys.

Next, image data which is uploaded when the business trip filter, the portrait filter, and the climbing filter are valid will be described with reference to the image data shown in FIGS. 2A to 2F.

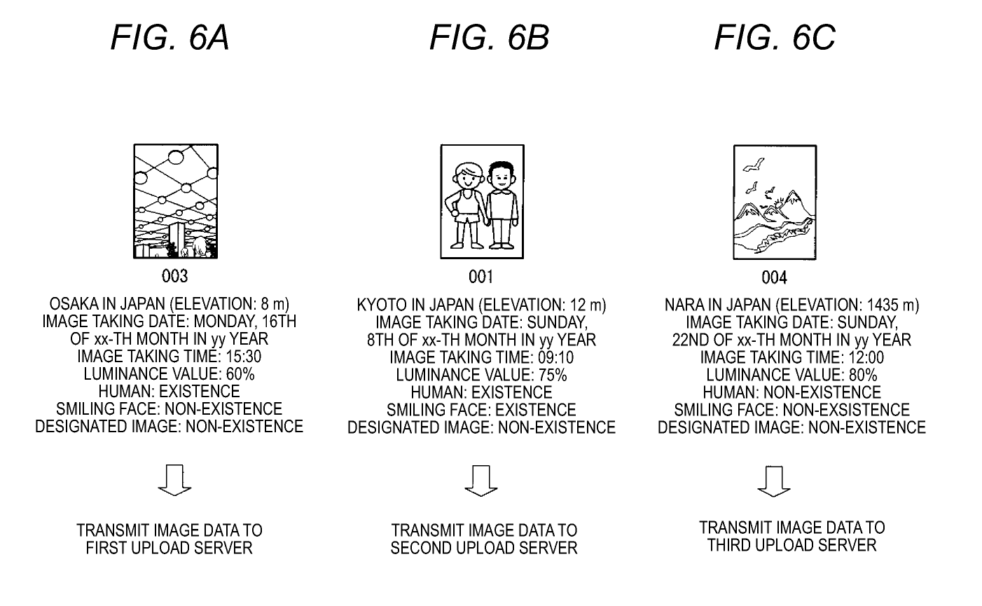

Referring to FIG. 6A, when the business trip filter is valid, if the image data ‘003’ (FIG. 2C) is stored and becomes a standby state, a human detection process, a smiling-face detection process, a luminance detection process, and an image difference detection process are performed on the image data ‘003’. As analysis results of the image data ‘003’, an average luminance value is 60%, a human detection result is ‘existence’, a smiling-face detection result is ‘non-existence’, and a difference detection result is ‘non-existence’. The analysis results and the meta information satisfy the predetermined conditions represented by the business trip filter, and thus the image data ‘003’ is uploaded to the first upload server 102a registered in association with the business trip filter. Since the noise reduction is in an ON state in the business trip filter, prior to the uploading, a noise reduction process is performed on the image data ‘003’.

Referring to 6B, when the portrait filter is valid, if the image data ‘001’ (FIG. 2A) is stored and becomes a standby state, the above-mentioned analysis processes are performed on the image data ‘001’. As analysis results of the image data ‘001’, an average luminance value is 75%, a human detection result is ‘existence’, a smiling-face detection result is ‘existence’, and a difference detection result is ‘non-existence’. The analysis results and the meta information satisfy the predetermined conditions represented by the portrait filter, and thus the image data ‘001’ is uploaded to the second upload server 102b registered in association with the portrait filter. Since the red-eye correction and the skin tone correction are in an ON state in the portrait filter, prior to the uploading, a red-eye correction process and a skin-tone correction process are performed on the image data ‘001’.

Referring to 6C, when the climbing filter is valid, if the image data ‘004’ (FIG. 2D) is stored and becomes a standby state, the above-mentioned analysis processes are performed on the image data ‘004’. As analysis results of the image data ‘004’, an average luminance value is 80%, a human detection result is ‘non-existence’, a smiling-face detection result is ‘non-existence’, and a difference detection result is ‘non-existence’. The analysis results and the meta information satisfy the predetermined conditions represented by the climbing filter, and thus the image data ‘004’ is uploaded to the third upload server 102c registered in association with the climbing filter. Since the color correction is in an ON state in the portrait filter, prior to the uploading, a color correction process is performed on the image data ‘004’.

As described above, the user can perform at least one of the red-eye correction process, the skin-tone correction process, the color correction process, and the noise reduction process on image data taken for upload.

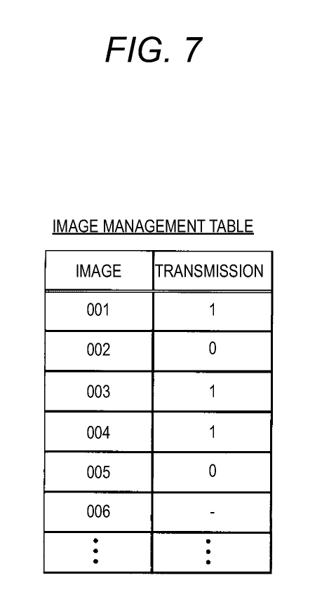

FIG. 7 is a conceptual view illustrating an image management table for managing the image data stored in the flash memory 32. Referring to FIG. 7, the image management table includes an image column and a transmission column. In the image column, the names of the image data stored in the flash memory 32 are recorded. In the transmission column, any one of a value ‘1’ representing that transmission has been completed, a value ‘0’ representing that transmission is incapable, and a mark ‘—’ representing that it has not been determined whether transmission is possible is recorded corresponding to the image column.

For example, since the image data ‘001’, ‘003’, and ‘004’ have been uploaded (transmitted), ‘1’ is recorded in the transmission column. Further, since the image data ‘002’ and ‘005’ do not satisfy the predetermined conditions represented by the filters, so as not be transmitted, ‘0’ is recorded in the transmission column. Furthermore, since it has not been determined whether the image data ‘006’ satisfies the predetermined conditions, the mark ‘—’ is recorded in the transmission column.

Therefore, it is possible to easily classify uploaded image data and image data incapable of upload.

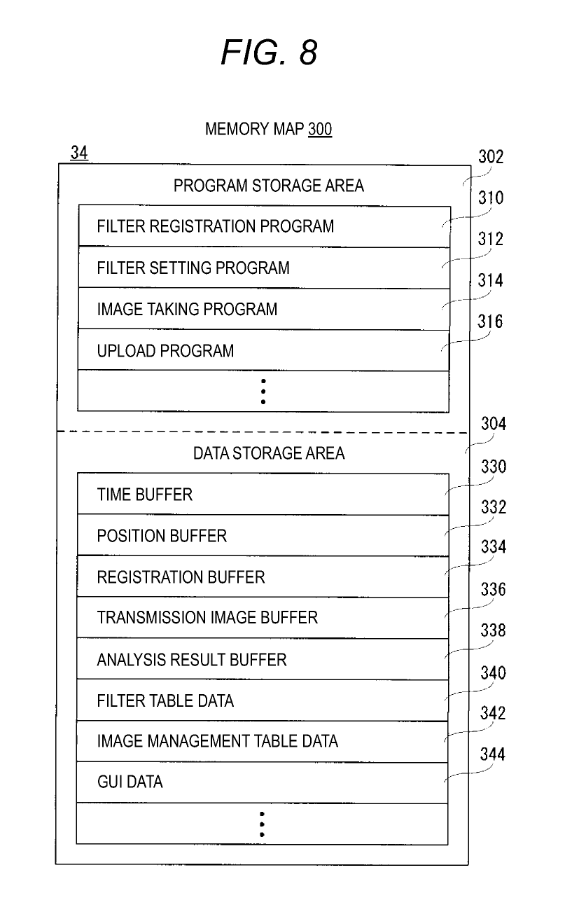

FIG. 8 is a view illustrating a memory map 300 of the RAM 34. The memory map 300 of the RAM 34 includes a program storage area 302 and a data storage area 304. Some of programs and data are read from the flash memory 32 at once or partially and sequentially if necessary, are stored in the RAM 34, and are processed by the processor 24.

In the program storage area 302, programs for operating the portable phone 10 are stored. For example, the programs for operating the portable phone 10 include a filter registration program 310, a filter setting program 312, an image taking program 314, an upload program 316, and so on. The filter registration program 310 is a program which is executed when a filter is registered. The filter setting program 312 is a program for performing switching of the valid/invalid of a registered filter, editing, and so on. The image taking program 314 is a program which is executed when an image of a photographic object is taken. The upload program 316 is a program for determining whether to upload image data stored by image taking operation.

Although not shown, the programs for operating the portable phone 10 may include a program for notifying a call reception state, a program for communication with the outside, and so on.

In the data storage area 304, a time buffer 330, a position buffer 332, a registration buffer 334, a transmission image buffer 336, and an analysis result buffer 338 are provided. Further, in the data storage area 304, filter table data 340, image management table data 342, and a GUI data 344 are stored.

In the time buffer 330, the time information output from the RTC 24a is temporarily stored, and the contents is updated with time. In the position buffer 332, a latitude, a longitude, and an altitude based on GPS signals are temporarily stored. In the registration buffer 334, when a filter registration process is being performed, data before a (iter table is registered is temporarily stored. In the transmission image buffer 336, corrected image data is temporarily stored. In the analysis result buffer 338, results of the human detection process, the smiling-face detection process, the luminance detection process, and the image difference detection process.

The filter table data 340 is table data configured as shown in FIGS. 4A and 4B. The image management table data 342 is table data configured as shown in FIG. 7. The GUI data 344 is data of images and characters for configuring a GUI to be displayed on the display 30.

Although not shown, in the data storage area 304, data of images and character strings to be displayed on the display 30, and the like may be stored, and a flag or a counter necessary for an operation of the portable phone 10 may be provided.

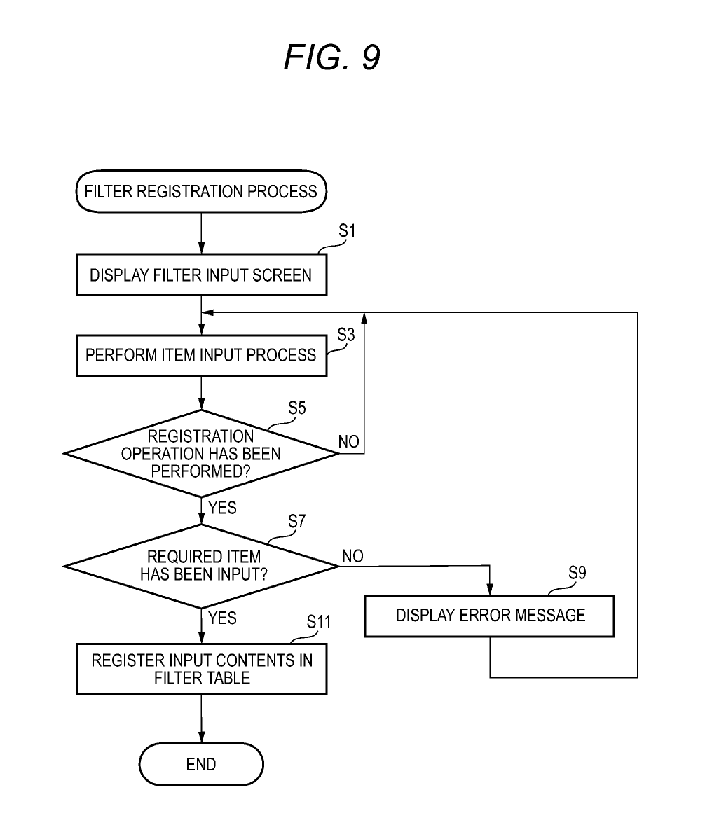

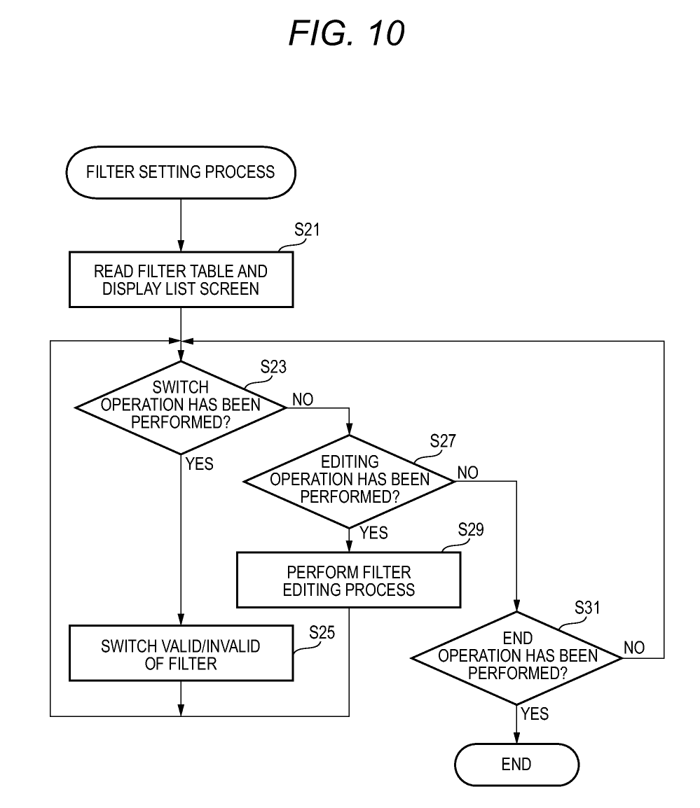

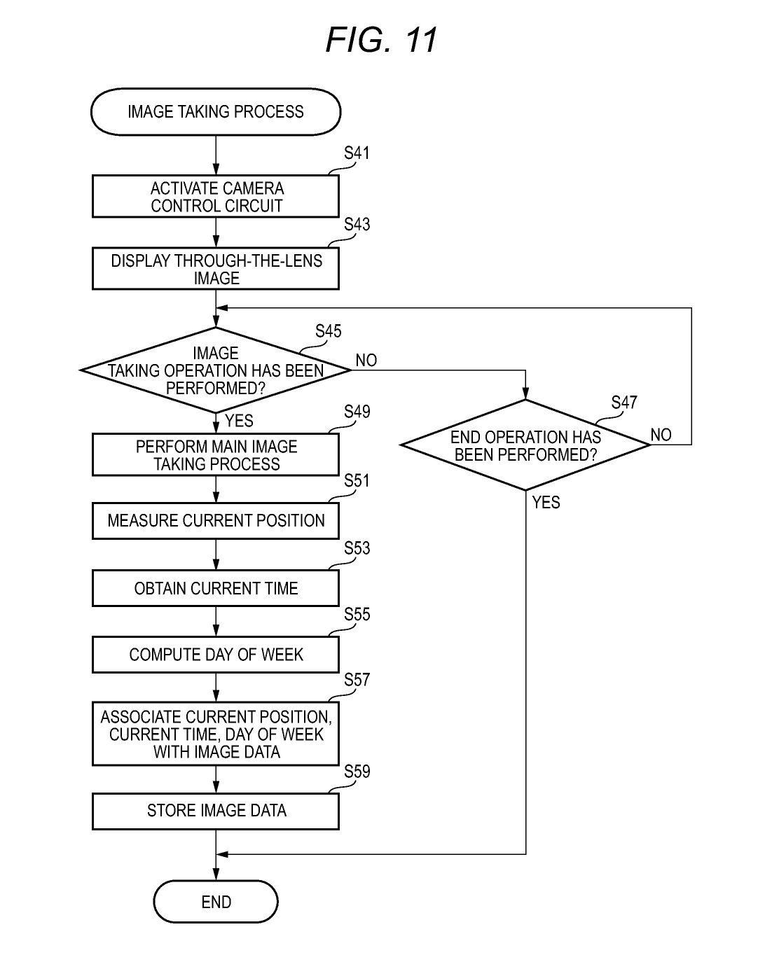

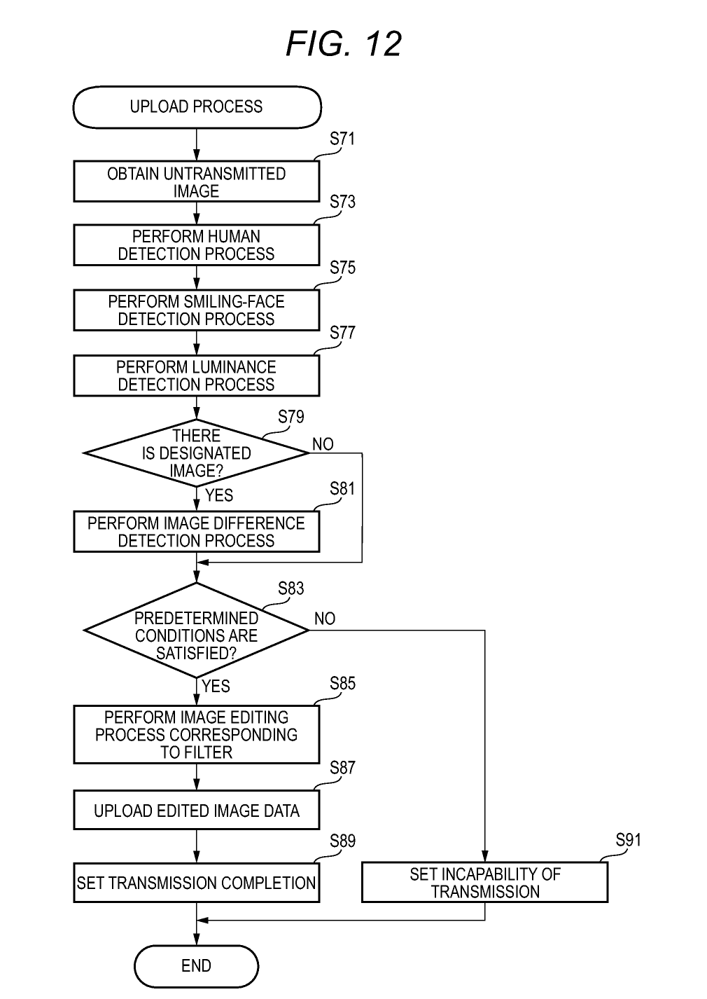

The processor 24 processes a plurality of tasks in parallel under the control of an OS based on Android (a registered trademark), an OS such as an REX, and Linux (a registered trademark) or other OSs. The plurality of tasks includes a filter registration process shown in FIG. 9, a filter setting process shown in FIG. 10, an image taking process shown in FIG. 11, an upload process shown in FIG. 12, and so on.

FIG. 9 is a flow chart of a filter registration process. For example, if an operation for registering a new filter is performed, the processor 24 displays a filter input screen on the display 30 in S1. In other words, the processor 24 displays the input screen shown in FIG. 3A on the display 30. Subsequently, in S3, the processor 24 performs an item input process. In other words, the processor 24 performs a process for selecting each icon by the cursor Cu or inputting an item corresponding to each icon. The input contents are temporarily stored in the registration buffer 334. For example, if the process of S3 is performed and the user performs input operation, the display of the display 30 changes from a state of FIG. 3A to a state of FIG. 3B.

Next, in S5, the processor 24 determines whether registration operation has been performed. In other words, the processor 24 determines whether registration operation for registering the input contents has been performed on the key input device 26. If a determination result in S5 is ‘NO’, that is, registration operation has not been performed, the processor 24 returns to S3. If a determination result in S5 is ‘YES’, that is, registration operation has been performed, in S7, the processor 24 determines whether a required item has been input. For example, the processor 24 determines whether a filter name has been input. If a determination result in S7 is ‘NO’, that is, the required item has not been input, the processor 24 displays an error message in S9, and returns to S3. For example, when the display 30 is displaying the state of FIG. 3A, if registration operation is performed, the processor 24 may display a message, ‘PLEASE INPUT A FILTER NAME’.

If a determination result in S7 is ‘YES’, that is, the required item has been input, the processor 24 registers the input contents in the filter table in S11, and ends the registration process of the new filter. In other words, the processor 24 adds the contents stored in the registration buffer 334 to the filter table data 340. If a GUI displayed on the display 30 is in the state shown in FIG. 3B, the business trip filter is registered in the filter table data 340, as shown in FIGS. 4A and 4B. The processor 24 performing the process of S11 functions as a registering unit.

FIG. 10 is a flow chart of a filter setting process. For example, if the user performs an operation for setting a filter, in S21, the processor 24 reads the filter table and displays a list screen. For example, the processor 24 may read the filter table data 340, and displays the list screen of FIG. 5 on the display 30. Subsequently, in S23, the processor 24 determines whether switch operation has been performed. In other words, the processor 24 determines whether the switch key 130 shown in FIG. 5 has been operated. If a determination result in S23 is ‘YES’, that is, a switch operation has been performed, the processor 24 switches the valid/invalid of the filter in S25, and returns to S23. For example, in a case where the business trip icon 120 shown in FIG. 5 has been selected by the cursor Cu and the switch key 130 has been operated, the value in the cell of the valid/invalid of the filter table shown in FIG. 4B switches from ‘1’ to ‘0’. In other words, the processor 24 switches the business trip filter from valid to invalid.

If a determination result in S23 is ‘NO’, that is, a switch operation has not been performed, in S27, the processor 24 determines whether editing operation has been performed. In other words, the processor 24 determines whether the editing key 132 shown in FIG. 5 has been operated. If a determination result in S27 is ‘YES’, that is, an editing operation has been performed, the processor 24 performs a filter editing process in S29, and returns to S23. For example, if the business trip icon 120 is selected by the cursor Cu and the editing key 132 is operated, the processor 24 reads data of the business trip filter from the filter table data 340, and displays the input screen of FIG. 3B on the display 30.

If a determination result in S27 is ‘NO’, that is, an editing operation has not been performed, in S31, the processor 24 determines whether an end operation has been performed. For example, the processor 24 determines whether an end key has been performed. If a determination result in S31 is ‘NO’, that is, the end key has not been operated, the processor 24 returns to S23. If a determination result in S31 is ‘YES’, that is, the end key has been operated, the processor 24 ends the filter setting process.

FIG. 11 is a flow chart of an image taking process. For example, if an operation for performing the camera function has been performed, in S41, the processor 24 activates the camera control circuit 36. In other words, the processor 24 issues an instruction for turning on a power source of the camera control circuit 36. Subsequently, the processor 24 displays an through-the-lens image in S43. In other words, the processor 24 displays an image of a photographic object taken by the image sensor 38. Next, in S45, the processor 24 determines whether an image taking operation has been performed. For example, the processor 24 determines whether a shutter key included in the key input device 26 has been operated. If a determination result in S45 is ‘NO’, that is, an image taking operation has not been performed, in S47, the processor 24 determines whether an end operation has been performed. For example, the processor 24 determines whether the end key has been operated. If a determination result in S47 is ‘NO’, that is, an end operation has not been performed, the processor 24 returns to S45. Meanwhile, if a determination result in S47 is ‘YES’, that is, an end operation has been performed, the processor 24 ends the image taking process.

If a determination result in S45 is ‘YES’, that is, an image taking operation has been performed, the processor 24 performs a main image taking process in S49. In other words, the processor 24 temporarily stores image data output from the camera control circuit 36 in the RAM 34. Subsequently, the processor 24 measures a current position in S51. In other words, the processor 24 activates the GPS control circuit 42 and obtains GPS signals. Then, the processor 24 computes the latitude, longitude, and altitude of the current position on the basis of the obtained GPS signals, and stores the result in the position buffer 332.

Subsequently, the processor 24 obtains current time in S53. In other words, the processor 24 reads a number string representing the current time from the time buffer 330. Next, the processor 24 computes the day of the week in S55. In other words, the processor 24 computes the day of the week corresponding to the current time read from the time buffer 330. Next, the processor 24 associates the current position, the current time, and the day of the week with image data in S57. In other words, the processor 24 sets the current position, the current time, and the day of the week computed in S51 to S55, as meta information, and associates the meta information with image data stored in the RAM 34. Subsequently, the processor 24 stores the image data in S59, and ends the image taking process. In other words, the processor 24 stores the meta information and the image data as one file in the flash memory 32.

FIG. 12 is a flow chart of an upload process. For example, if image data has being stored, the portable phone 10 transitions to the standby mode, and an arbitrary filter is valid, the processor 24 obtains an untransmitted image in S71. In other words, the processor 24 reads image data, for which the mark ‘—’ is in the transmission cell on the basis of the image management table data 342, from the flash memory 32. The image data read from the flash memory 32 is stored in the transmission image buffer 336. Next, the processor 24 performs the human detection process in S73. For example, if the processor 24 performs the human detection process, the processor 24 determines whether a skin color area having a predetermined size is included, on the image data stored in the transmission image buffer 336. Then, a result of the human detection process is stored in the analysis result buffer 338.

Subsequently, the processor 24 performs a smiling-face detection process in S75. For example, if the processor 24 performs the smiling-face detection process, a face is extracted from the image data stored in the transmission image buffer 336. On the basis of a feature amount of the extracted face area and a feature amount of a template of a face, a smile degree representing what degree of smile of a face is computed from the feature amount of the extracted face area. On the basis of whether the computed smile degree is a predetermined value or greater, it is determined that a smiling face is included in the image data. A result of the smiling-face detection process is stored in the analysis result buffer 338.

Next, in S77, the processor 24 performs the luminance detection process. In other words, the processor 24 detects an average luminance value from the image data stored in the transmission image buffer 336. The detected average luminance value is stored in the analysis result buffer 338.

Subsequently, in S79, the processor 24 determines whether there is a designated image. In other words, the processor 24 determines whether there is a designated image in the designated-image difference cell of the filter table, in a valid filter. If a determination result in S79 is ‘NO’, that is, there is no designated image, the processor 24 proceeds to S83. Meanwhile, if a determination result in S79 is ‘YES’, that is, there is a designated image, the processor 24 performs an image difference detection process in S81. For example, the processor 24 reads the image designated in the designated-image difference cell of the filter table, and compares the designated image with the image data stored in the transmission image buffer 336, thereby detecting whether there is a change between the designated image and the image data stored in the buffer. A result of the difference detection is stored in the analysis result buffer 338.

The processor 24 performing the processes of S73 to S81 functions as an analyzing unit.

Next, in S83, the processor 24 determines whether valid predetermined conditions are satisfied. For example, in a case where the business trip filter is set to be valid, the processor 24 determines whether meta information fo the image data stored in the transmission image buffer 336, and a plurality of analysis results stored in the analysis result buffer 338 satisfy the predetermined conditions represented by the business trip filter. The processor 24 performing the process of S83 functions as a determining unit.

If a determination result in S83 is ‘YES’, for example, if the predetermined conditions represented by the business trip filter are satisfied, the processor 24 performs image editing processes corresponding to the filter in S85. For example, if the predetermined conditions represented by the business trip filter are satisfied, the noise reduction process is performed on the image data stored in the transmission image buffer 336. The image data having reduced noise is restored in the transmission image buffer 336. The processor 24 performing the process of S85 functions as an editing unit.

Next, in S87, the processor 24 uploads the edited image data. For example, if the business trip filter is valid, on the basis of the URL (hhp://abcO.com) registered in association with the business trip filter, the processor 24 transmits the image data stored in the transmission image buffer 336, to the first upload server 102a. The processor 24 performing the process of S87 functions as an uploading unit.

Subsequently, the processor 24 sets ‘transmission completion’ in S89, and ends the upload process. For example, if the original image data stored in the transmission image buffer 336 is the image data ‘003’, ‘1’ representing transmission completion is stored in the transmission cell corresponding to the image ‘003’ in the image management table data 342.

If a determination result in S83 is ‘NO’, for example, if the predetermined conditions represented by the business trip filter are not satisfied, the processor 24 sets ‘incapability of transmission’, and ends the upload process. For example, if the original image data stored in the transmission image buffer 336 is the image data ‘006’, ‘0’ representing that transmission is incapable is recorded in the transmission cell corresponding to the image ‘006’ in the image management table data 342. The processor 24 performing the process of S91 functions as a setting unit.

After the image data is uploaded, the edited image data is erased. However, in other illustrative embodiments, the edited image data may be stored.

As can be appreciated from the above-description, if the portable phone 10 has the camera module including the camera control circuit 36, and image taking operation is performed, the image data is stored in the flash memory 32. If the image data is stored and the portable phone 10 becomes the standby mode, the processor 24 analyzes attributes (such as an average luminance value) which the stored image data represents. Further, the processor 24 determines whether the analysis result of the stored image data satisfies a predetermined condition (for example, whether an average luminance value is 80% or less), on the basis of the filter stored in the RAM 34. If the stored image data satisfies the predetermined condition, the image data is uploaded to the upload server 102a.

As described above, since it is enabled to set an attributes which image data represents, as a condition for upload, the user can set a detailed condition. Therefore, upload of image data is appropriately performed.

The contents registered as a filter may be either the image taking conditions or the image conditions. In other words, only items of the image taking conditions or items of the image conditions may be set in the filter input screen.

In other illustrative embodiments, a contrast value or the like may be included in attributes that image data represents. As the editing processes performed prior to uploading, an image rotation or inversion process, a trimming process, a size change process, a white balance correction process, and so on may be selected. Further, the editing processes may not be performed on image data to be uploaded.

In a case where image data of one image satisfies a plurality of predetermined conditions, the image data may be uploaded to a plurality of upload server 102. In this case, the image data stored in the flash memory 32 is set as master data, and a plurality of editing processes is performed on the image data in accordance with an upload destination server. Further, priorities may be set on filters, such that image data of one image satisfying a plurality of conditions is uploaded to only a site registered in association with a filter having the highest priority.

In other illustrative embodiments, if a new filter is registered and set to be valid, or a registered valid filter is edited, it may be determined on all image data in the flash memory 32 whether predetermined conditions represented by the corresponding filter are satisfied.

In other illustrative embodiments, when an operating rate of the processor 24 becomes a predetermined value or less, the upload process shown in FIG. 12 may be performed.

In other illustrative embodiments, video data may be uploaded. In this case, the human detection process, the luminance detection process, and the like are performed on still images sampled at predetermined intervals, and on the basis of the analysis result, it is determined whether predetermined conditions that a filter represents are satisfied.

A communication method of the portable phone 10 is a CDMA method; however, it may be a long term evolution (LTE) method, a W-CDMA method, a GSM method, a TDMA method, an FDMA method, a PHS method, etc.

The filter registration program 310, filter setting program 312, the image taking program 314, and the upload program 316 may be stored in a HDD of a server for data distribution, and be distributed to the portable phone 10 through a network. Those programs may be stored in computer-readable media including optical discs such as CDs, DVDs, Blu-ray Discs (BDs), USB memories, memory cards, and so on, and the computer-readable medium may be sold or distributed. In a case where the filter registration program 310, filter setting program 312, the image taking program 314, and the upload program 316 downloaded from the server or the recording medium are installed a portable phone having the same configuration as the present illustrative embodiment, the same effects as those of the present illustrative embodiment can be achieved.

The inventive concept of the present invention is not limited to the portable phone 10, but may be applied to a smart phone and a personal digital assistant (PDA).

The specific values of the number of pixels, the time, the altitude, the average luminance value exemplified in this specification are merely examples, and may be appropriately changed according to the need attributable to the specifications and the like of products.

What is claimed is:

1. A portable communication terminal comprising:
an image taking unit configured to output taken image data;
an analyzing unit configured to analyze an attribute which the image data represents;
a determining unit configured to determine whether an analysis result of the analyzing unit satisfies a predetermined condition; and
an uploading unit configured to upload the image data to an upload server when the determining unit determines that the analysis result satisfies the predetermined condition.

2. The portable communication terminal according to claim 1, further comprising:
an editing unit configured to perform an editing process on the image data when the determining unit determines that the analysis result satisfies the predetermined condition,
wherein the uploading unit uploads the image data edited by the editing unit.

3. The portable communication terminal according to claim 1, further comprising:
an input unit configured to receive an input operation; and
a registering unit configured to register a result of the input operation to the input unit as the predetermined condition.

4. The portable communication terminal according to claim 1, further comprising:
a setting unit configured to set the image data as image data incapable of transmission when the determining unit determines that the analysis result does not satisfy the predetermined condition.

5. The portable communication terminal according to claim 1, wherein the predetermined condition is registered in association with address information of the upload server.

6. The portable communication terminal according to claim 1,
wherein the analyzing unit analyzes a luminance value of the image data, and
wherein the predetermined condition includes whether the luminance value of the image data is a predetermined value or more.

7. The portable communication terminal according to claim 1,
wherein the analyzing unit analyzes a smile degree of the image data, and
wherein the predetermined condition includes whether the smile degree of the image data is a predetermined value or more.

8. The portable communication terminal according to claim 2,
wherein the editing unit performs, as the editing processes, at least one of a red-eye correction process, a skin-tone correction process, a noise reduction process, and a color correction process, on the image data.

9. A non-transitory computer-readable medium having an upload control program stored thereon and readable by a processor included in a portable communication terminal having an image taking unit configured to output taken image data, the upload control program, when executed by the processor, causing the processor to perform operations comprising:
analyzing an attribute which the image data represents;
determining whether an analysis result satisfies a predetermined condition; and
uploading the image data to an upload server when it is determined that the analysis result satisfies the predetermined condition.

10. An upload control method of a portable communication terminal having an image taking unit configured to output taken image data, the method comprising:
analyzing an attribute which the image data represents;
determining whether an analysis result satisfies a predetermined condition; and
uploading the image data to an upload server when it is determined that the analysis result satisfies the predetermined condition.
